(19) United States
(12) Patent Application Publication
(10) Pub. No.: US 2026/0057821 A1
(43) Pub. Date: Feb. 26, 2026

(54) MICRODISPLAY

(71) Applicant: Fraunhofer-Gesellschaft zur Förderung der angewandten Forschng e.V., München (DE)

(72) Inventors: Uwe VOGEL, Dresden (DE); Philipp Wartenberg, Dresden (DE); Bernd Richter, Dresden (DE); Dirk Schlebusch, Dresden (DE); Steffen Damnik, Dresden (DE); Andreas Fritscher, Dresden (DE); Stephan Brenner, Dresden (DE); Gerd Bunk, Dresden (DE)

(21) Appl. No.: 19/372,621

(22) Filed: Oct. 29, 2025

Related U.S. Application Data
(63) Continuation of application No. PCT/EP2024/061775, filed on Apr. 29, 2024.

(30) Foreign Application Priority Data
Apr. 30, 2023 (DE) 102023204007.7

(51) Int. Cl. G09G 3/20

(52) U.S. Cl. CPC G09G 3/2096; G09G 2320/045; G09G 2320/0626; G09G 2340/0435

(57) ABSTRACT

Microdisplay architecture, comprising: an optical plane with several pixel elements; a circuit plane on which the optical plane is arranged; wherein the circuit plane includes one or several interfaces, a pixel matrix control as well as an image memory for controlling the several light-emitting or light-modulating elements in dynamically selectable operating modes.

### CROSS-REFERENCE TO RELATED APPLICATIONS

This application is a continuation of copending International Application No. PCT/EP2024/061775, filed Apr. 29, 2024, which is incorporated herein by reference in its entirety, and additionally claims priority from German Application No. 102023204007.7, filed Apr. 30, 2023, which is also incorporated herein by reference in its entirety.

Embodiments of a present invention relate to a microdisplay as well as to an operating method. Preferred embodiments relate to a microdisplay comprising at least one memory-based operating mode. Further embodiments relate to a microdisplay comprising a leakage circuit. According to embodiments, the operating method can be computer-implemented. Generally, the invention is in the field of scalable microdisplay architectures.

### BACKGROUND OF THE INVENTION

Microdisplays describe displays having a typical display diagonal of 0.1″ to typically 1.5″, some selected ones even up to 2.5″. Such microdisplays are usually structured in a stacked manner, i.e., the control circuit is located immediately below (therefore in the following referred to as backplane) the elements to be controlled (in the following, referred to collectively as frontplane). Depending on the field of application and the optical usage of the microdisplay, these elements to be controlled can be a layer system for realizing an organic LED, an inorganic LED or an LC material. Accordingly, they are called OLED microdisplay, micro LED microdisplay (uLED or μLED are also common) or LCOS (liquid crystal on silicon) microdisplay.

Here, the control circuit is adapted to specific properties of the element to be controlled. Examples are: precise electric control in the typical voltage range of 3V or higher, good current injection into the layer and measures for aging compensation in OLED microdisplays, high current densities of more than 1A/cm² for uLED microdisplays or even no static current flow whatsoever into the element to be controlled for LCOS microdisplays.

For realizing an active matrix display, the backplane includes circuit components, such as transistors, capacitors or resistors. The same can be implemented in different technologies. Exemplarily, these are thin layer transistors (TFT such as IGZO, a-Si or LTPS) or realization in monocrystalline silicon. In the following, the further discussion will be based without limitation on the monocrystalline silicon with CMOS circuit technology (others are possible). By continuous progress of TFT miniaturization, a partial realization on TFT is also possible as a perspective.

According to conventional technology, microdisplays based on a silicon backplane are mainly realized in technology nodes of 0.25 um . . . 90 nm.

In microdisplays, a distinction can be made between different control variants, wherein, depending on the control variant, the architectures, i.e., the system architecture and pixel architecture are normally different. The majority of microdisplays is driven by a video stream with constant refresh rate, i.e., for example by a video data stream with 30 Hz, 60 Hz, 90 Hz, 120 Hz or 240 Hz. In the following, this type of architecture is referred to as “refresh rate-based architecture”. There are only a few control schemes deviating therefrom, one example is [1] presenting an architecture for partly updating pixels (in the following, this describes the smallest element controllable independently from other elements). In the following, this type of architecture is referred to as “memory-based architecture”.

The selected architecture is considered in combination with the technological platform, as the space requirements for the respective architecture, especially for microdisplays, is such that not every system or pixel architecture is produced with every technological platform.

All of these above architecture have in common that they include, apart from the control circuit for the optical elements, as further circuit blocks, a row and column decoder, possibly a DAC functionality for “translating” the digital pixel data into current and voltage values for the pixel as well as a block for realizing a display data interface (parallel interface, LVDS, SPI or the same) in dependence on the above-stated control principle.

This dependency results from the needed data bandwidth:

“Refresh rate-based architecture” needs, for example, a much higher data rate as all display pixels are overwritten at all times, even when this is not needed, since, for example the value of the pixel has not changed at all. For this, normally a parallel interface (i.e. parallel digital single-ended lines that together transmit the data value of the pixel or of several pixels as well as further control lines, also referred to as digital RGB, or serial transmissions (e.g. LVDS, low-voltage differential signaling) are used. Such systems involve very expensive external video control electronics, which realizes transformation to the stated interfaces. Normally, this takes place by a separate integrated circuit or an FPGA. This increases the needed power consumption as well as the installation space (and is hence disadvantageous for the ergonomics of a system), both these factors are of great significance in numerous wearable applications.

However, for the “memory-based architecture” the transmission of the changing pixels is sufficient. Depending on the application, this significantly reduces the needed transmission bandwidth, such that less complex interfaces, such as SPI, can be considered. One example for this can be found in [1]. In each of these cases, an adapted control circuit is needed.

Microdisplays according to conventional technology realize pixel sizes in the range of 4.3 um×4.3 um . . . 6.3 um×2.1 um . . . 9.3 um×3.1 um.

### SUMMARY

According to an embodiment, a microdisplay architecture may have: an optical plane comprising several light-emitting or light-modulating elements; a circuit plane on which the optical plane is arranged; wherein the circuit plane comprises one or several interfaces, a pixel matrix control as well as an image memory for controlling the several light-emitting or light-modulating elements.

According to another embodiment, a microdisplay architecture may have: an optical plane with several light-emitting or light-modulating elements; a circuit plane on which the optical plane is arranged, wherein the circuit plane comprises a pixel matrix control for controlling the light-emitting or light-modulating elements, wherein the pixel matrix control comprises one or several transistors forming an additional leakage circuit.

According to another embodiment, a method for controlling an inventive microdisplay architecture may have the steps of: operating the pixel matrix control in the memory-based operating mode by using the image memory; or operating the pixel matrix control in a memory-based operating mode by/without using the image memory.

Another embodiment may have a non-transitory digital storage medium having a computer program stored thereon to perform the inventive method when the method runs on a pixel matrix control.

Embodiments of the present invention provide a microdisplay architecture with an optical plane and a circuit plane. The optical plane, oriented towards the top in the discussion, includes several light-emitting or light-modulating elements, which are arranged, for example in an n×m pixel matrix. The underlying circuit plane consists of several circuit components, at least a circuit group for controlling the individual optical elements (also pixel circuit), programming circuit for the circuit groups allocated to the individual optical elements (also called pixel matrix control), an integrated image memory as well as one or several interfaces, such as wired and wireless interfaces.

According to embodiments, the pixel control includes one switch and one driver per pixel.

According to further embodiments, by using small technology nodes (e.g. <90 nm) it is possible to integrate more functionality directly into the backplane (circuit plane). This is accompanied by a significant simplification of the system architecture, if the connections to layered standard display interfaces, which were previously made externally, can be replaced and can in that way be integrated and the interfaces can thus be integrated directly into the backplane.

According to further embodiments, by using small technology nodes (e.g. <90 nm), as well as a specific pixel circuit, it is possible to realize very small pixels, for example 3.5 um×3.5 um, 3 um×3 um, 2.5 um×2.5 um, 2 um×2 um or below. Here, the configuration of the individual pixels does not necessarily have to be square. For example, it can be advantageous to implement the same in rectangular (so that three pixels combined into one group or consisting of a red, green or blue pixel again result in square) or hexagonal shape.

According to further embodiments, the pixel matrix control can be configured to control the several light-emitting/modulating elements with a refresh rate-based operating mode or memory-based operating mode. Preferably, the operating mode can be switched, (e.g. depending on the application or current field of usage.

Embodiments of the present invention are based on the finding that the usage of a highly scaled technology (for example <90 nm) allows to integrate the circuits of the external components directly into the backplane and to omit additional driver circuits. Integrating a frame buffer into the backplane allows operating the microdisplay as needed as “memory-based architecture” or “refresh rate-based architecture”. The definition of memory-based architecture or refresh rate-based architecture is given above in the context of conventional technology and applies here as well. Thereby, the aspects technological platform, system architecture and pixel architecture go hand in hand and provide the following advantages or the basis for obtaining the following advantages:
drastic simplification of system architecture complexity
significantly reduced packaging complexity by using integration options of external components (such as frame buffer, CPU/GPU, wireless interface etc.)
cost efficiency also by 300 mm wafer processes that are standard for <90 nm technologies (more chips per wafer) such as 65 nm, 45 nm, 32 nm, 28 nm, 22 nm, 12 nm, and less
realization of extremely high refresh rates by image memories connected in a highly parallel manner to the pixel matrix
flexible architecture for controlling different frontplane technologies OLED/uLED (common cathode, common anode) as well as LCOS
flexible adaptation of current consumption to the application by switching off modules or adapting the control

According to embodiments, the above-defined backplane (circuit plane) can be combined with different frontplane architectures (OLED, uLED, LCOS) and can serve to control the same. Thereby, a flexible architecture for controlling different frontplane technologies OLED/μLED (common cathode, common anode) as well as LCOS is provided.

According to embodiments, the circuit plane or the backplane can directly comprise the circuits or switching circuits of the one or several interfaces, the pixel matrix control as well as the image memory. This means that the circuits or switching circuits of the one or several interfaces, the pixel matrix control as well as the image memory are integrated in the circuit plane. Thus, an integrated switching circuit is arranged in the circuit plane, i.e., an integrated switching circuit is provided in the form of the backplane with the stated functional blocks. According to further embodiments, additional, i.e., one or several additional functional blocks can exist as additional components of the integrated switching circuit. Each of the functional blocks, for example illustrated in FIG. 6, would basically be suited for that. In that way, a further embodiment provides a circuit plane or backplane with circuits or an integrated switching circuit including the functional blocks interface, pixel control and image memory as well as one or more further functional blocks of the example of FIG. 6.

According to embodiments, with the highly scaled technology, a small pixel cell is realized. The main driver for this requirement is a continuously higher resolution. Further, by flexible configuration of the overall architecture, the backplane can be used for most diverse plane architectures.

According to embodiments, the microdisplay architecture does not only comprise one but several interfaces, e.g. several interfaces of different types (wired and wireless) and/or several interfaces of different bandwidth.

Examples for suitable wired interfaces are HDMI, display port, MIPI, Thunderbolt, USB. Further, direct integration of wireless interface into the backplane is possible, exemplarily Bluetooth, WLAN, openThread, LoRaWAN, AirTag, RFID. According to embodiments, with suitable circuit complexity on the display, there is a third option of transferring information instead of video data. Displaying the information takes place, for example on the display directly on suitable hardware (for example integrated GPU/CPU) and possibly, according to embodiments only in the needed display areas that are currently used for display (foveated rendering). All examples have in common that they dramatically simplify the further system electronics and thereby reduce both current consumption, possibly bandwidth to be transmitted, the form factor and hence the costs of the system.

Further, according to embodiments, by integrating several interfaces directly into the backplane, the adaptation to most diverse system results, which presents a significant cost advantage, since several system applications can be served with the identical integrated backplane switching circuit and pricing in semiconductor industry heavily depends on quantities. Further, implementing several interfaces according to embodiments results in the option of flexible adaption of the interface to the current operating mode.

According to embodiments, selecting the transmission interface or the respective transfer mode depends on the selection of the operating mode. For a memory-based operating mode, for example, an interface with low bandwidth, such as a Bluetooth interface can be used, while in a refresh rate-based operating mode an interface with higher bandwidth, such as by means of an MIPI interface is used.

According to embodiments, not only pixel data can be transmitted via the interface of the microdisplay chip. Rather, the abstract transmission of information to be displayed can take place when by integrating a suitable CPU/GPU in the backplane pixel data are generated directly. By transmitting information instead of individual pixel data, the needed bandwidth of the interface can be significantly reduced, which results in advantages in the system (reduced current consumption, reduced complexity of external circuit components and hence system costs). The CPU/GPU can be switched off, for example, or can be placed into a sleep mode, for example, when the memory-based operating mode is activated. In that way, flexible adaptation of the current consumption to the application by switching off modules or adaptation of the control is possible.

According to embodiments, this transformation of information into display data can take place directly in the display backplane for all pixels or merely for part of the pixels that currently contribute to the actual display (so-called foveated rendering). By generating merely actually used display data in the backplane, flexible adaptation of the current consumption to the application is possible.

According to embodiments, areas of the microdisplay architecture, i.e., several light-emitting/modulating elements allocated to first group and several light-emitting/modulating elements allocated to a further group can be operated in a different manner (different sequences and/or amplitudes) or even in different operating modes (simultaneous control of different areas in the video/memory mode). This means that operating takes place in a first display part or display area by display area is operated in a refresh rate-based operating mode, while a further display part is operated in a memory-based operating mode. It is also possible that only parts of the display are operated at the current time. All these measures advantageously serve to increase the energy efficiency, since by switching off components or display areas or also operating display areas with a more energy efficient operating mode lowers the current consumption overall. A significant difference for the different operating modes is the update rate. The same can be varied according to embodiments. For example, a 1 Hz update rate for the memory-based operating mode (lower update rate) can be used, or, for equal display content, an update of the data can be even completely omitted, i.e., an image frequency of 0 Hz can be used (equals no activity on the external interface and accompanying extreme energy savings), while higher update rates, e.g., 30 Hz, 60 Hz, 90 Hz or even >120 Hz are used for the refresh rate-based operating mode. Generally, the update rate can be varied, i.e., variable in a range >30, >60, >90 or >120 Hz. The adaptation of the image frequency according to the application allows also flexible adaptation of the current consumption, as higher image frequencies are accompanied by higher current consumption.

By using the memory, local frame rate adaptation (from the input to the output of the memory) as well as extended processing (inserting intermediate images) can take place.

Here, the difference between image frequency indicating the provision of new data on the input side of the image memory, and image refresh rate on the output side of the image memory describing the transfer rate of the data of the image memory into pixels should be noted. According to embodiments, at the pixel control and the frame buffer, a first refresh rate can be applied on the input side a and a second refresh rate can be applied on the output side, wherein the second refresh rate is at least equal or higher.

According to embodiments, transfer of data from the integrated image memory is configured with a very high bandwidth. The same is enabled by direct integration of the memory into the backplane, in particular when using small technology nodes (<90 nm). This enables the refresh rate to be significantly higher, for example, 240 Hz, 480 Hz, 1 kHz, 5 kHz, 10 kHz, 20 kHz, 50 kHz, 100 kHz, or above. The application-specific adaptation of the refresh rate allows also flexible adaptation of the current consumption since higher refresh rates are accompanied by higher current consumption.

According to embodiments, transfer of data from the image memory to the pixel takes place by a freely programmable cyclical transfer mimic (also called sequence) which allows, apart from the transfer of the data itself, extended processing, such as inserting generically generated data frames (without using data from the image memory, such as black images) and delaying elements for time weighting of the currently displayed data.

According to embodiments, individual pixel subgroups can be controlled by different sequences (and/or different amplitudes). By different sequences and/or different amplitudes, different modes of operation are configured. Thereby, individual groups of optical elements can be controlled differently (including by not limited to the individual insertion of generally generated data frames as well as delaying elements), and in that way adaption of the optical characteristics of these pixel subgroups can be realized (for example, tuning of red, green and blue subpixels for white point adjustment).

According to a further embodiment, it is also possible that the bit depth, e.g., the bit depth describing the brightness/gray level per light-emitting/modulating element or also describing the color per light-emitting element with subpixels is variable. Some applications need high color/gray level resolutions, such that a high bit depth is desired, while individual bit levels for other applications can be deactivated. This reduces the computing effort and therefore increases the energy efficiency.

In the above-mentioned CMOS technology nodes of <90 nm, there is an increase of leakage currents, which can be compensated by a leakage circuit of the circuit plane and therefore have no influence on the optical plane. Therefore, according to further embodiments of the circuit plane of the microdisplay architecture, the microdisplay architecture comprises a leakage circuit. According to embodiments, the same can include two additional transistors.

Here, it should be noted that, according to embodiments, the image memory can be realized completely in pixel, partly in the pixel, or also outside the display pixel but within the same integrated switching circuit. In the minimum configuration, a one-bit memory per pixel is integrated in the pixel control circuit. Obviously, several one-bit memories, i.e., a memory having a higher memory depth can be provided per pixel. The higher memory depth can also be obtained by arranging the further bits also outside the display pixels but within the same integrated switching circuit (memory partly integrated in pixels). According to embodiments, the image memory can be switched off partly, completely, or in stages. Especially in the variant discussed above according to embodiments with different bit depths depending on the operating mode or depending on the application, the step-wise switching off is useful, as the entire memory space per cell is no longer needed. According to embodiments, the memory can also be bypassed, e.g., for the refresh rate-based operating mode.

From a geometrical point of view, according to embodiments, a pixel extends both in the circuit plane and in the optical plane. In the circuit plane, each pixel comprises, for example, one driver (per pixel) and one or several memory cells (per pixel). In the optical plane, one optical element each, such as one OLED is provided per pixel.

In the following, two different embodiments for the optical plane will be discussed. One variant is the so-called common anode circuit, while another variant can be realized by a common cathode circuit.

According to embodiments, the several light-emitting elements are implemented as common cathode circuit. Here, the pixel control per light-emitting element can be configured as follows: the pixel control comprises a transfer gate as well as a driver (in the most simple case, an inverter), wherein the driver switches an LED with a common electrode against the reference voltage Vref, for example, the pixel matrix control is configured to increase the brightness by decreasing the reference voltage V_{ref} or by increasing the pixel voltage Vₚᵢₓ₁; generally, the difference Vpix−Vref is changed in order to change the brightness of the light-emitting/modulating elements. Alternatively, the control is configured to control different light-emitting elements or pixel partial elements by different pixel voltages.

According to embodiments, the several light-emitting elements of the microdisplay architecture are configured as common anode circuit. Here, the pixel matrix control can be configured to control a common anode as counter electrode with the same backplane. For brightness regulation: for example, the pixel matrix control is configured to increase the brightness by increasing the reference voltage V_{ref} or by decreasing the pixel voltage Vₚᵢₓ.

According to embodiments, individual pixel subgroups can be controlled with different pixel voltages/currents. Thereby, individual groups of optical elements can be controlled with different voltages and in that way, tuning of the optical characteristics of these pixel subgroups can be realized (for example, tuning of red, green and blue subpixels for white point adjustment).

A further embodiment of a further aspect provides a microdisplay architecture with an optical plane and a circuit plane. The optical plane comprises several light-emitting/modulating elements. Above that, the circuit plane comprises a leakage compensation circuit. According to embodiments, the same can include two additional transistors. According to embodiments, the microdisplay architecture comprises a technological platform <90 nm.

Implementation variants discussed in the context of the main aspect, can obviously also be used in this further aspect.

A further embodiment provides a method for operating a microdisplay architecture. The method includes the steps of
operating the pixel matrix control in the memory-based operating mode by using the image memory: or
operating the pixel matrix control in the memory-based operating mode by using the image memory or operating the pixel matrix control in a refresh rate-based operating mode.

According to embodiments, the method can also be computer-implemented, for example, as software on the playback device instructing the display architecture to activate the respective operating mode.

### BRIEF DESCRIPTION OF THE DRAWINGS

Embodiments of the present invention will be detailed subsequently referring to the appended drawings, in which:

FIG. 1 is a schematic illustration of the cross-section of a microdisplay structure according to a basic embodiment;

FIG. 2 is a schematic illustration of a simple pixel basic circuit for discussing embodiments;

FIG. 3a is a schematic illustration of a realization in terms of circuit engineering of a simple pixel basic circuit (variant with common cathode frontplane) according to embodiments;

FIG. 3b is a schematic illustration of a realization in terms of circuit engineering of a simple pixel basic circuit (variant with common anode frontplane) according to further embodiments;

FIG. 4 is a schematic illustration of a realization in terms of circuit engineering of a simple pixel basic circuit with leakage current compensation according to further embodiments/in further aspects;

FIG. 5 is a schematic illustration of a complex example of a pixel cell with (partial) implementation of the frame buffer in the pixel cells according to embodiments; and

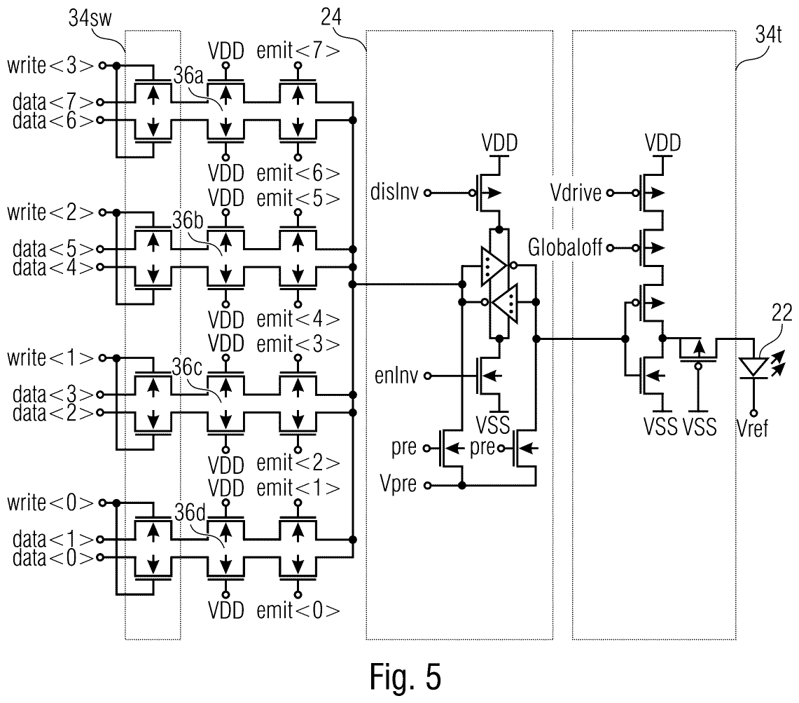

FIG. 6 is a schematic block diagram of a flexible microdisplay architecture according to embodiments.

### DETAILED DESCRIPTION OF THE INVENTION

In the following, embodiments of the present invention will be discussed based on the figures. It should be noted that equal elements and structures are provided with the same reference numbers, such that the description of the same is interapplicable or interexchangable.

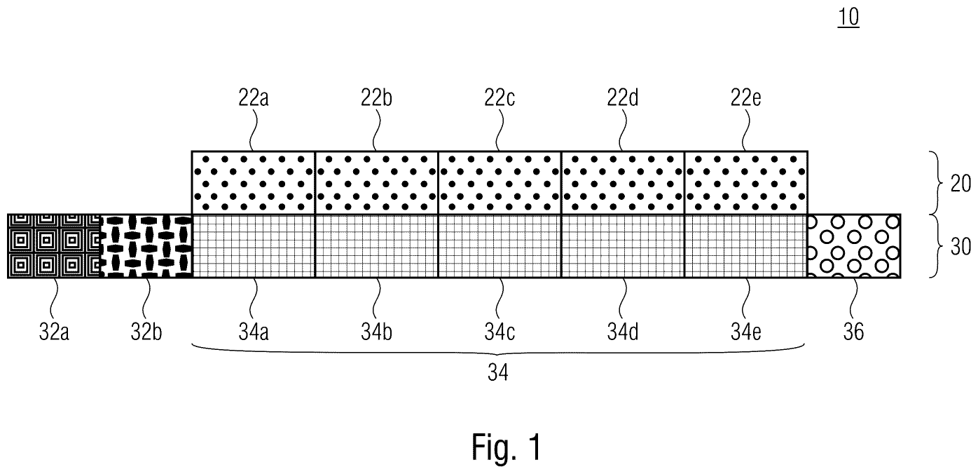

FIG. 1 shows a microdisplay architecture 10 in a schematic illustration. The same includes an optical plane (frontplane) 20 as well as a circuit plane (backplane) 30. The optical plane 20 is disposed on the circuit plane 30. The optical plane 20 comprises a plurality of optical elements. The same can be arranged next to each other or in an n×m pixel matrix, i.e., in a planar manner. The circuit plane 30 comprises a pixel matrix control 34 as well as a memory, such as a frame memory 36. The pixel control can be provided per pixel (cf. 34a-f) and in that way, form a direct coupling/geometrical relationship to the light-emitting elements 22a, 22b, 22c, 22d, 22f. One driver, for example, can be provided per element 34a-f. The memory 36 can also comprise one or several memory cells per pixel. The memory is configured as one-bit memory as a minimum (one bit per pixel), but can also include several memory cells per pixel (e.g., 8 bit). Primarily, the memory is implemented as internal memory. The same can also be configured as a partly external memory, i.e., some memory cells per pixel are arranged externally. The internal memory cell is arranged, for example, in the pixel area itself. The external memory cell can, for example, be provided in the edge areas of the same integrated switching circuit.

Above that, the backplane 30 comprises one or several interfaces, such as communication interfaces each provided with reference number 32a, 32b, respectively. It should be noted that the interface 32b represents an optional interface.

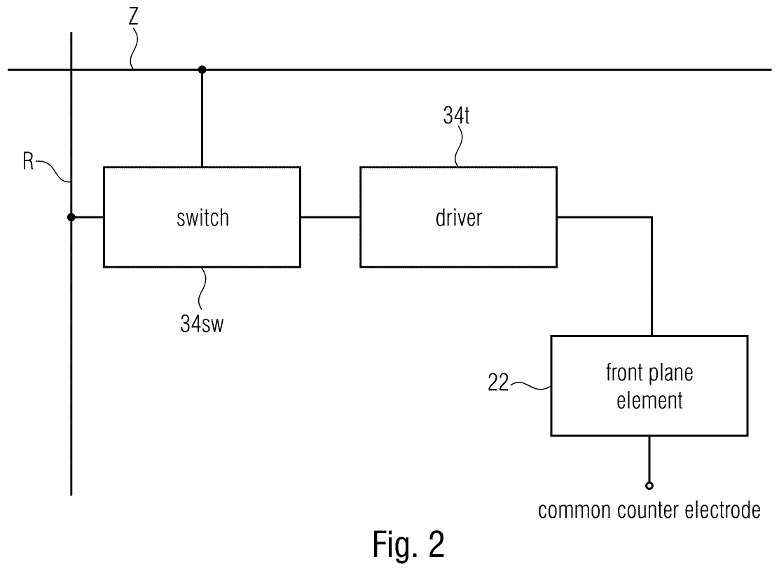

The control 34 can either control the several light-emitting elements 22a-22f directly by a refresh rate-based operation or control the several light-emitting elements by means of the memory 36 in the memory-based operating mode. The processors for the memory-based operating mode and the transfer-rate based operating mode can be separate, i.e., individual processors are provided for the individual modes, such that, when the respective mode is not activated, the respective processor is deactivated or placed in the standby mode. This enables current savings. The information to be displayed by means of the several pixels 22a-22f are obtained via the one or several interfaces 32a and 32b, for example, in a data format (image stream) to be displayed directly or as “compressed” data format. The interfaces 32a and 32b typically have different bandwidths, such that the data rates to be transferred vary. For example, a refresh rate-based mode needs a higher data rate than the memory-based mode, since only the changes of the image have to be transferred in the latter. According to embodiments, only one piece of information can be transferred, which is then converted into an image by means of a GPU. The control 34 an be extended by a GPU/CPU, which serves as an alternative interface and can display, for example, information provided from the outside graphically by means of the arrangement 10. Controlling the individual light-emitting elements 22 takes place as illustrated, for example, in FIG. 2.

For illustrating this advantage, a microdisplay 10 having an MIPI interface 32a as well as a Bluetooth interface 32b will be discussed in the application for smart glasses in a maintenance scenario. This scenario starts with assigning the object (including work assignment, work location) to a maintenance engineer. Then, the smart glasses are to show the way to the work location for the maintenance engineer. Thus, the display has the task of supplying respective directions into the smart glasses. In this operating mode, the information on the display changes only within a very limited range (for example, directional arrows and the time are indicated) as well as in a very moderate frequency (an update of the display with 1 Hz is sufficient). Supplying the data can hence take place easily via Bluetooth directly from the mobile phone of the maintenance engineer or also by a GPS/Galileo/GLONASS/Beidou (or similar satellite navigation systems) module as well as associated data processing and display unit (CPU/GPU) integrated in the microdisplay architecture. Finally, the critical work location is reached. As the maintenance engineer is responsible for different systems, he requires respective technical support by an expert from the central support center. For this video call and support during maintenance, a complete video is to be displayed on the microdisplay in the smart glasses, i.e., all image points of the display have to be written. Further, for a satisfying interaction, it is needed to display this with a high refresh rate of at least 60 Hz, 90 Hz, 120 Hz, 240 Hz or more. The data for this are exemplarily provided from an external mobile processor via an MIPI interface 32a. After the advice from the support agent, the task can be fulfilled, the call is terminated, the complete data processing pipeline of the video call including the mobile processor can return to the sleep mode/standby and navigation to the next work location is continued.

This scenario shows the advantage of the inventive different operating modes when it can be switched flexibly between “memory-based architecture” (for example, in the navigation case, few image changes at a low refresh rate or even idle data transfer when no changes occur in the display) and “refresh rate-based architecture” (in the support case, when displaying a video or latency-critical interaction). In a portable system, each advantage is exponentiated in the current consumption, as the system, on the one hand, can be used longer between two charging cycles or, on the other hand, a smaller energy storage can be integrated in this system, whereby size and/or weight of the system can be reduced, wherein again the ergonomics of the system are improved. This presents a significant system requirement for a portable system.

The data of the standard interface 33a/b (wired or wireless) are stored in an image memory 36 (frame buffer) after reception. Implementing a complete image memory having a memory depth of 8 bit per pixel or more has so far not been possible, as the memory in the technologies >90 nm typically used for microdisplays would have taken up too large an area of the chip, or would have resulted in a dramatic increase of the chip and hence to less chips on a wafer and hence, again, to an excessive increase of the cost per individual backplane chip. This changes dramatically with smaller process nodes <90 nm, as the memory density (i.e., realizable memory cells per area) increases significantly with smaller process nodes.

For example, the frame buffer (also image memory) acts as decisive intermediary block between the flexible external circuit architecture of the standard interface 32a/b as well as the internal control of the pixels. Here, the image memory can be realized outside the pixels, partly within the pixels, or also completely within the pixels.

Realization completely within the pixels normally results in greater pixels (for example, as dynamic memory DRAM, as static memory SRAM, or as non-volatile NVRAM) as, apart from the memory, a driver circuit has to be integrated as well. However, this inventive architecture variant needs less circuit technology outside the matrix. Also, cyclical transfer of the data into the pixel is omitted.

In contrast to this, there is the second variant of the pixel, wherein the circuit complexity of the pixel is reduced to the minimum and hence allows a very small pixel (i.e., enables the largest pixel density and hence a higher resolution on a specific microdisplay area). Such a pixel circuit reduced to the minimum includes merely one switch separating the actual driver from the column line (cf. FIG. 2). In a specific application, the driver can also be a simple storing element (e.g., capacitance).

FIG. 2 shows a light-emitting element with associated pixel control, here, for example, with a common electrode (common cathode/anode electrode of the optical elements). The light-emitting or light-modulating element 22 is controlled via a driver 34d, which is again programmed and controlled via a row-selection switch by the column data. The switch is provided with reference number 34sw. For row selection, the switch 34sw receives a respective signal.

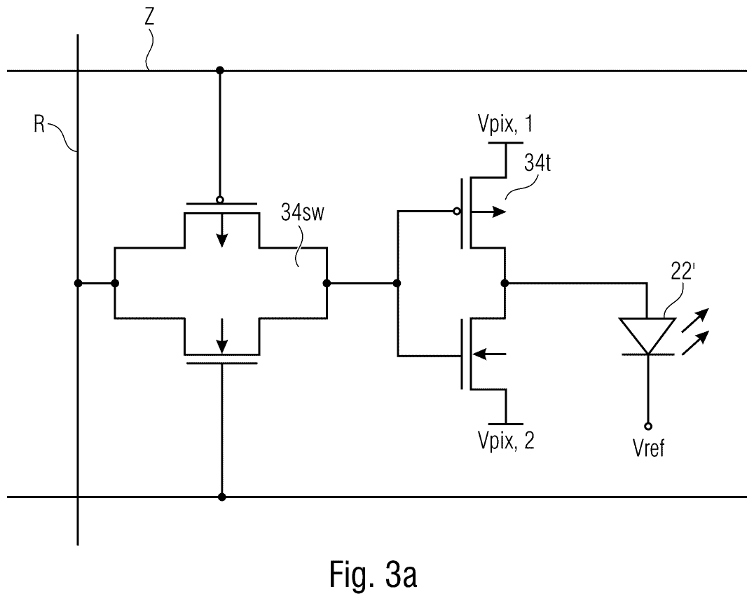

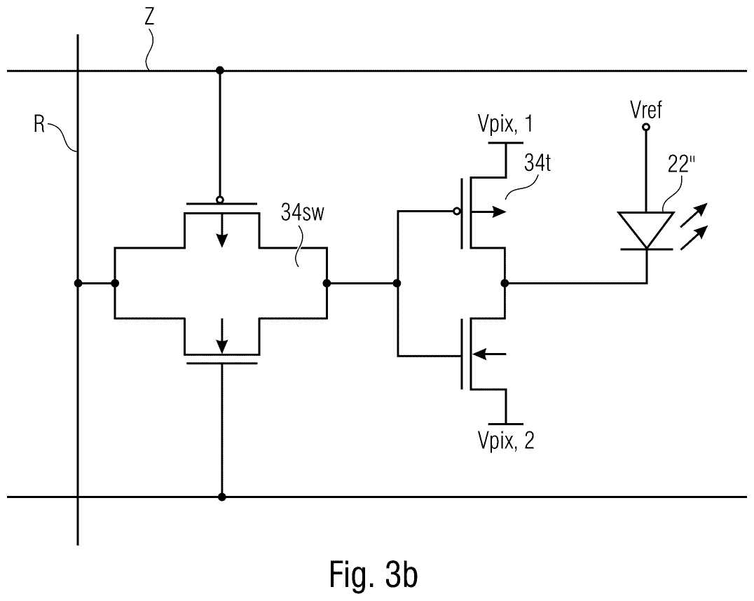

In terms of circuit engineering, an implementation of these basic elements is illustrated in FIG. 3a. In this example, the switch 34sw is realized by a transfer gate and the driver by an inverter 34t. A light-emitting diode 22′ (corresponds to 22 with common cathode circuit), which is connected to a common electrode Vref, is assumed as load in the front panel element. In this illustration, the common electrode is a common cathode, as the (O) LEDs 22′ of all pixels have a common cathode as counter electrode.

In this example, the global brightness can be adjusted in two different ways: decreasing V_{ref} or increasing the Vpix1 voltage. For realizing this, both voltages are configured separately and can also be controlled separately. For a correct control of the pixel cell, when adapting Vpix1, the column voltage level on the vertical data lines (corresponds to implementation of voltage converters/level shifters in the column head of the pixel matrix) is also adapted. In a configuration with statically fixed pixel voltage, the same can be omitted, then, global brightness adjustment is possible, e.g., by adapting the sequence, e.g., by inserting black images or controlling the common electrode. Here, it should be noted that when using a CPU/GPU or the integrated pixel matrix control in the circuit plane these black images can also be generated locally and are not transmitted from the outside, according to embodiments.

In a further embodiment, it is also possible that pixels provided with different frontplane elements are configured with differently adjustable Vpix1,1, Vpix1,2, Vpix1,3. This is particularly useful with a requirement of different electrical control parameters for the different frontplane elements. An example for this is the configuration of red, green, and blue front panel elements with different electrical parameters, which can be suitably controlled by the separate configuration. Additionally, via these different adjustment options, the brightness of the individual pixels and hence, for example, the white point of the microdisplay can be adjusted. The same advantages result for the separate configuration of Vref in the form Vref1, 1, Vref1,2, Vref1,3, etc.

Also, an individual control can be realized by the inventive embodiment of different pixel groups that are again allocated to different and independently adjustable sequences. This embodiment also makes it possible to adjust different groups of frontplane elements (for example, different current efficiency) independently of each other (for example, as above for white point adjustment of R, G, B).

However, according to embodiments, a “common anode” design, i.e., a frontplane having a common anode as counter electrode can be controlled with the same backplane. This is illustrated in FIG. 3b based on the circuit of 22″ (22″ corresponds to 22 with common anode circuit). In such an arrangement, the voltage of the common counter electrode is in the positive range (cf. FIG. 3b), i.e., brightness control can be realized by increasing V_{ref} or decreasing Vpix2. It is obvious that the digital data in an “common anode” design are to be inverted compared to the data of a “common cathode” design. According to embodiments, this can either take place in the column head or also prior to storage in the frame buffer. Further, the implementation of different voltages for separate pixel groups as explained above can also be realized in an adapted form for the “common anode” design. The same applies regarding the sequence of differently configured pixel groups as above.

In both cases, this simplified pixel cell realizes merely two states-in the following referred to as “on” and “off.” For implementing gray levels, it is needed to write a temporal impulse sequence of “on” and “off” states into the pixel cell. This temporal sequence is realized by a programmable sequencer. The same controls both reading out of the correct data from the frame buffer as well as the correct selection of the display row belonging to the data. The more gray levels have to be resolved, the more transfers are needed, as well as a larger frame buffer. According to embodiments, the same is configured such that it complies with the maximum requirements. In application cases with lower bit depth (for example, displaying navigation instructions does not require 8 bit or more resolution per color channel), the inventive flexible architecture includes the option of switching off of the unnecessary memory cells of the frame buffer step-by-step (for example, from 16 bit to 8 bit per pixel, 8 bit to 4 bit or also 13 bit to 7 bit, etc.). This results also in an adapted sequence for transmitting the data from the frame buffer to the pixels, as less “on” and “off” states have to be realized. Both are accompanied by significant savings in current consumption and emphasize the flexibility of the inventive new architecture. When maintaining the same transmission frequency but a shorter sequence length of the transmission from the frame buffer to the pixels, a higher refresh rate is enabled by reducing the bit depth.

In the above explanation, light-emitting elements, such as OLEDs or uLEDs have been assumed. Alternatively, a light-modulating element, such as LCOS can be used.

The above embodiments of FIGS. 3a and 3b can thus be summarized such that, per pixel or pixel group to be controlled, one switch 34sw that is, for example, implemented by a transfer gate in the driver 34d that is, for example implemented by an inverter, can be provided. The light-emitting diode (for example, an OLED or LED) is coupled to the output of the inverter and in that way, comprises an anode or common cathode. For LCOS (light-modulating element) cyclical polarity reversal takes place.

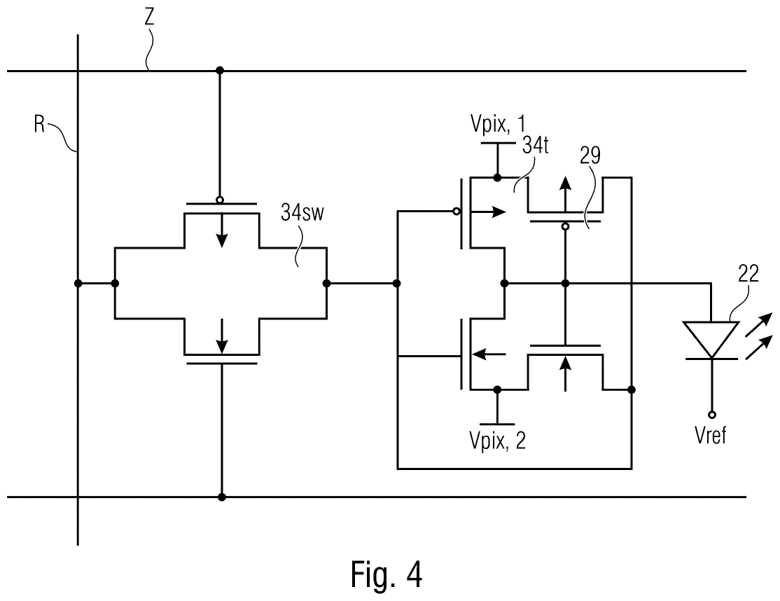

According to the characteristics of the technology, further transistors are useful in this simplified pixel cell. As in these embodiments, reference is made in particular to technologies of smaller structural sizes (needed for inventive implementation of flexible interface assemblies, the frame buffer and others), a further embodiment of the pixel cell will be illustrated herein. Smaller technology nodes are characterized by so-called leakage currents (for example, drain source leakage current, gate leakage current, or also bulk leakage currents). These parasitic currents basically increase with more advanced technology nodes and result, according to conventional technology, to an undesired current flow through the optical element in pixel cells and hence, possibly to a reduced contrast ratio (as the optical element cannot be completely switched off). Further, the conventional exemplary pixel cell has assumed that the inner node of the pixel cell maintains the stored digital value after programming. However, due to the above-explained leakage currents, this is possibly only the case for a limited amount of time and additionally depends, to a large extent, on the circuit conditions (for example, pixel voltage and temperature). Thus, FIG. 4 shows a pixel circuit extended by two transistors 29 for compensating these leakage currents. The two transistors 29 form a leakage current compensation circuit.

The two transistors of the leakage compensation circuit 29 comprise a common control electrode coupled to the output of the inverter. The transistors re-coupled to the input node of the driver realize a compensation of the leakage current. Control of the optical element 22 takes place by means of the inverter 34t.

Above that, the same provide for the leakage currents (for example, of the driver) to be dispensed through the circuit and do not flow off through the frontplane. For example, this circuit ensures two decisive characteristics of the new architecture for compensating the leakage currents:
A good contrast ratio even for increasing leakage currents: leakage currents guided through the frontplane element result in a corruption of the control, in particular, in the desired “off” state of the pixel cell and hence, to a “residual illumination” of the pixel even in the “off” state and hence, to a reduction of the decisive parameter contrast ratio of a microdisplay. In that way, this is prevented.
Continuous reception of the state of the pixel cell: by the two additional transistors 29, reception of the programmed state is ensured, even across a longer time period.

With reference to FIG. 9, control of an optical element 22 by means of the driver 34t as well as a readout amplifier 24 realized in the pixel control for the memory elements (36a-d) that are also realized in the pixel will be discussed. The switches 34sw are connected to the exemplarily illustrated eight memory cells 36a, 36b, 36c and 36d per pixel. The eight memory cells 36a-36d allow realization of an 8 bit memory. Obviously, these memory cells can also be increased by further pixel internal and external memories (that are integrated in the same circuit). Here, the memory cells are (partly) implemented directly in the pixel cell. The readout amplifier 24 (for DRAM embedded in the pixel) can be provided between memory cell 36a-36d and driver 34t.

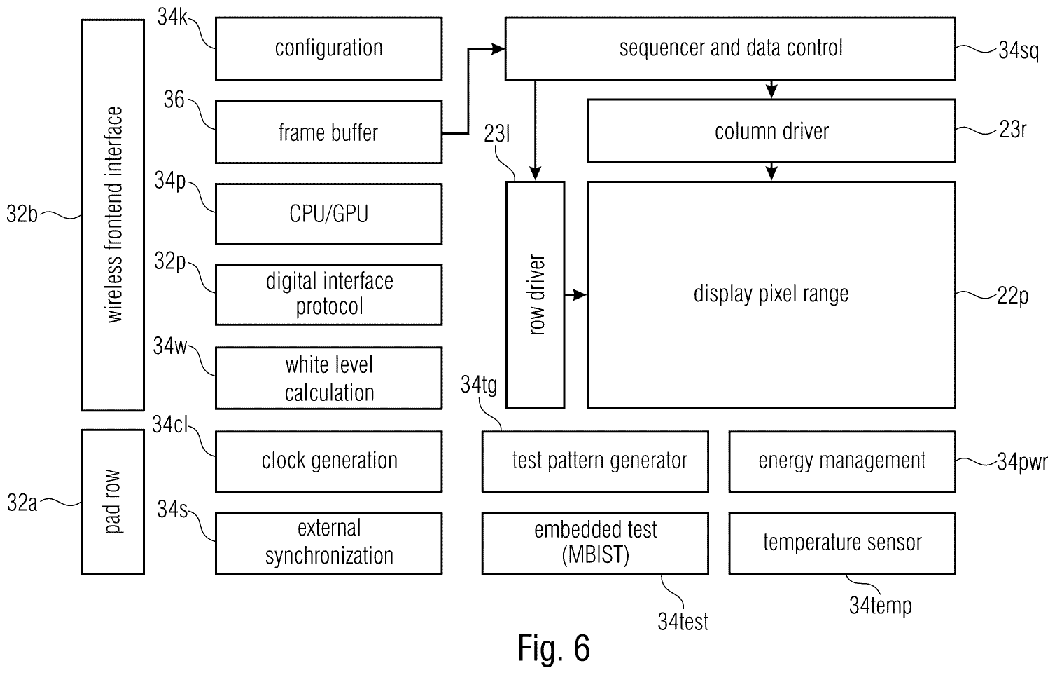

With reference to FIG. 6, functional blocks allocated to the frontplane of the display architecture (cf. reference numeral 20) as well as the circuit plane of the display architecture (cf. reference number 30) and particularly, the control 34 will be discussed in detail. FIG. 6 shows a block diagram of a flexible microdisplay architecture. The same mainly includes the pixel area 22p which is controlled as a matrix via a row driver 231 and a column driver 23r. Further, FIG. 6 shows further functional blocks for controlling the pixel area 22p. The pixel area 22p includes, per pixel in the circuit plane, elements such as driver 34t and switch 34sw as well as the light-emitting elements 22 in the optical plane.

According to embodiments, the circuit plane includes a column driver 23r and/or a road driver 231. The same are both again controlled via a sequencer 34sq in the data flow control. The data flow control/the sequencer 34sq represents interfaces to the control unit 34 or the memory 36.

The control 34 can additionally comprise functional blocks, which can either be implemented in software or in hardware, i.e., as separate components or separate circuit groups, such as configuration unit 34k, processor (CPU) or graphic processor (GPU) 34p, white compensation 34w, external synchronization unit 34s, pad series for the wired interfaces 32a, energy management 34pwr, temperature sensor 34temp, test pattern generator 34tg, test unit 34test, internal clock generator 34cl. These units are to be considered as optional units, such that the same can exist separately.

In the following, the just-stated elements will be discussed regarding their mode of operation. Accordingly to embodiments, the flexible architecture also includes the mode of the mere 1-bit display. In that case, according to embodiments, the usage of the frame buffer can also be completely omitted for this single pixel, as there is no necessity of data storage in the frame buffer as the pixel cell stores the value up to the reception of new data. In order to allow complete switching-off of the frame buffer, this mode has the option of programming the pixel by writing directly, i.e., by bypassing the frame buffer.

Accordingly, for the embodiment of the partial integration of the frame buffer into the pixel cell (with more than 1 bit) the limit of the part of the frame buffer implemented in the pixel cell applies.

In the following, coupling the frame buffer 36 to the pixel matrix (cf. 231 and 23r in FIG. 6 or also in FIG. 2, column R and row Z) will be explained. The connection of the frame buffer 36 to the pixel matrix 22 with the row drivers 231 and 23r can be realized in different ways. According to conventional technology, the pixels 22 are programmed according to the subsequently arriving data stream or data of one row are collected and then written into the pixel matrix 22, therefore, the duration of a row typically includes at least a number of clocks according to the number of optical elements of a row. According to the invention, by completely implementing a complete frame buffer 36, a further option results: the data are not fetched individually from the memory 36, but rather the data of an entire row with one clock. Depending on the sequence length (the same is determined by the scan scheme but, for example, also by the bit depth) and implemented clock frequency, refresh rates or data transfer rates of unprecedented heights in microdisplays result. This is due to the fact that the new architecture includes all these modules on an integrated switching circuit. In the conventional separate implementation, such a bandwidth would need so many signals between driver module and backplane that the same cannot be implemented in a useful manner (neither regarding the wiring nor regarding current consumption of the drivers). In a highly integrated chip, it is possible, even at high resolutions, to read out all columns from the memory in parallel. The actual transfer rate can be influenced by the sequencer and therefore corresponds to the maxim of the present invention of realizing a very flexible architecture. The range for this transfer is between 0 Hz and several 1, 5, 10, 20, 50, 100 kHz or more, depending on resolution and frequency. Depending on the application, the refresh rate can be balanced against current consumption as needed by the application. Above that, the sequencer allows further features that are important in the field of augmented reality (AR) and virtual reality (VR), such as inserting black images (for preventing motion blur, and motion sickness).

In other words, this means that 36 and 34sq allow variants of the trigger clock and hence the refresh rate as well as the transferred bit depth in order to make the microdisplay architecture 10 flexible. Thus, in the flexible microdisplay architecture, it is possible to influence the connection of the frame buffer 36 by transferred bit depth, transmission frequency used, insertion of generically generated data frames (without using data from the frame buffer, such as black images), delaying elements for time weighting of the currently displayed data. All these parameters allow a tradeoff between displayed content and current consumption of the system. This applies even more when the actual data (this includes display data themselves as well as display data generated on the chip from information data) are also adapted. For example, an adapted bit depth provides for lower data bandwidth of the input interface or lower load of the CPU/GPU 34p, lower utilization of the frame buffer 36, lower needed transmission of the pixel matrix 22 as well as decrease of the current consumption. According the architecture, this adaptability can be used throughout the system down to an individual frame.

According to embodiments, one of the following units or functions can be integrated into the microdisplay 10 or the data processing means 34 of the microdisplay 10:

Implementation of temperature sensor 34temp for intra-system compensation of temperature effects. This allows integrated temperature dependent tracking of the pixel voltage or the common counter electrode. In other words, according to embodiments, the circuit plane comprises a temperature sensor 34temp and the control circuit 34 is configured to track the pixel voltage based on the temperature signal.

According to the further embodiments, the unit 34 or 34k can perform auto-calibration of the brightness by measuring the brightness back at a reference structure.

The functional unit 34test serves for integrated memory and system testing for individual system monitoring. The functional units 34tg comprise a test pattern generator for generating test data on the chip itself. Here, a test can also be performed during production, i.e., a production test by means of these units 34test or 34tg.

According to further embodiments, the functional unit 34pwr comprises a central power management unit realizing the above-explained scaling of the current consumptions by suitable switching-off of power domains. According to further embodiments, an external synchronization (cf. 34s) would also be possible. The same serves to provide different synchronization signals for external voltage generation, such as an inverting signal for the LCOS case or also synchronization to the end of a sequence (for example, for a specific synchronization with the optical system).

Further, adjustable clock generation 34cl for adapting the different frequency domains of the chip to the requirements of the respective application case (for example, clock frequency for controlling the frame buffer and the sequence memory) is possible. According to further embodiments, integrated white level calculation, e.g., in the case of the operation of the backplane in a quad pixel arrangement consisting of red (r), green (g) and blue (b) as well as white (w) can be performed (cf. 34w).

According to a further embodiment, the backplane can comprise, for example, an integrated voltage regulator for Vᵢₙ, V_{ref} and the pixel voltages. Gamma calibration would also be possible. These elements are provided as assemblies of the circuit plane.

Above that, the circuit plane can also include the interfaces 32 and in particular, interface 32p. This interface controls the selection of the interfaces 32 or the interface 32b, 32a or possibly the data transfer to the CPU/GPU 34p as well as feeding the display data generated by the CPU/GPU into the frame buffer (in the case of an information data interface). The pad row 32a is configured to couple in a physical input. Switching between 32a and 32b takes place with the unit 32p (digital interface protocol) as protocol plane.

In the following, embodiments of the present invention will be considered separately and in particular, reference is made to alternative implementations or more detailed implementations.

An embodiment provides a flexible microdisplay architecture, characterized in that one or several frontplane elements are arranged on a backplane and can be controlled through the same, several wired and/or wireless interfaces for data transmission are available, as well as a complete or partial image memory is realized on the backplane.

According to embodiments, it would be possible that the backplane is realized in CMOS technology. Preferably, CMOS technology ≤90 nm is used.

According to embodiments, the backplane can be realized in CFT technology.

According to embodiments, the backplane comprises one or several interfaces. According to embodiments, the interfaces or a standard interface of the one or several interfaces can be selected depending on the application.

According to embodiments, the backplane can be operated both as memory-based architecture and as refresh rat-based architecture. According to embodiments, the operating mode of the microdisplay depends on an algorithm realized in hardware or software, such that adaptation to image content and/or current applications is possible in a dynamic manner.

Regarding the image memory to be noted that the same can be realized completely, partly, or merely with one bit in the pixel cell. In that way, according to embodiments, instead of completely within the pixel, the memory can be arranged also partly outside of or within the edge area of the backplane. Regarding the bit memory, it should be noted that the same can be switched off partly or completely and/or can be bypassed. According to embodiments, the controlled bit depth of the pixels can be variably adjusted. According to embodiments, specific leakage compensation measures are provided in pixels.

According to embodiments, specific leakage compensation measures are realized in the pixel cell. Additional transistors between the driver of the optical element and the optical element itself are possible.

Here, it should be noted that the unit generally described above as light-emitting element can be implemented as LED, OLED, or μLED. Each pixel can include an LED or subpixels (several LEDs, e.g., for RGB). According to embodiments, the frontplane can be implemented in the light-modulating LCOS or light-emitting μLED or OLED.

According to embodiments, apart from the image memory, a driver adapted to the frontplane technology can be implemented. According to embodiments, depending on the configuration, the pixel cell is implemented as a common anode and/or common cathode, which serves as a control. Alternatively, the frontplane can be configured without any common electrode.

According to an embodiment, an image memory having a high bandwidth can be connected to the pixel matrix and can realize both refresh rates (for example, 240 Hz, 480 Hz, 1 kHz, 5 kHz, 10 KHz, 20 kHz, 50 kHz, 100 kHz and more). According to embodiments, the actual bandwidth between frame buffer and pixel matrix can be adapted. According to embodiments, system internal compensation of temperature effects in a backplane would be possible by implementing a temperature sensor. Here, according to embodiments, integrated temperature-dependent tracking of the pixel voltage or the common counter electrode can be realized in the backplane.

According to embodiments, auto calibration of the brightness is possible by measuring the brightness back at a reference structure.

According to embodiments, an integrated memory and system test unit for actual system monitoring or performing of a simplified product test is provided.

According to embodiments, a test pattern generator serves to generate test data on the backplane.

A further embodiment provides an arrangement as explained above with a central power management unit for scaling the current consumption by suitably switching-off power domains.

A further embodiment provides a unit for synchronizing the microdisplay architecture with further external components.

According to embodiments, an adjustable clock generation for adapting the different frequency domains of the chip to the requirements of the respective field of application (for example, clock frequency for controlling the frame buffer and the sequence memory) can be implemented.

According to embodiments, the pixel matrix control can comprise a sequencer that is configured to provide different refresh rates (for example, 240 Hz, 480 Hz, 1 kHz, 5 kHz, 10 KHz, 20 kHz, 50 kHz, 100 kHz and more) from the memory to the light-emitting or light-modulating elements (internal refresh rate).

According to embodiments, the pixel matrix control can comprise programmable and/or dynamically configurable cyclic transfer mimics configured to control between the memory and the light-emitting or light-modulating elements (dynamically and/or according to the programming).

According to an embodiment, the backplane can be provided for operation in a quad pixel arrangement, e.g., consisting of red (r), green (g) and blue (b) as well as white (w) and for this the data value of, for example the white pixel, is determined. According to an embodiment, automatic balancing of the white point of the microdisplay is possible. For that, a unit for white balance according to embodiments is provided.

According to embodiments, an integrated voltage regulator generating the pixel voltage is provided. According to further embodiments, gamma calibration in the backplane is provided.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Vogel-77-1.pdf, Vogel et al., “Ultra-low Power OLED Microdisplay for Extended Battery Life in NTE Displays”.

1. Microdisplay architecture, comprising:
an optical plane comprising several light-emitting or light-modulating elements;
a circuit plane on which the optical plane is arranged;
wherein the circuit plane comprises one or several interfaces, a pixel matrix control as well as an image memory for controlling the several light-emitting or light-modulating elements.

2. Microdisplay architecture according to claim 1, wherein the circuits of the one or several interfaces, the pixel matrix control as well as the image memory are integrated directly in the circuit plane.

3. Microdisplay architecture according to claim 1, wherein the pixel matrix control is configured to control the several light-emitting or light-modulating elements in a refresh rate-based operating mode.

4. Microdisplay architecture according to claim 1, wherein the pixel matrix control is configured to control the several light-emitting or light-modulating elements in a memory-based operating mode.

5. Microdisplay architecture according to claim 1, wherein the pixel matrix control is configured to selectively switch between several operating modes.

6. Microdisplay architecture according to claim 1, wherein the same comprises several interfaces and/or several interfaces of different bandwidths and/or several interfaces of different communication topology comprising wired or wireless communication topologies.

7. Microdisplay architecture according to claim 6, wherein the selection of the transfer interface and/or transfer mode takes place in dependence on an operating mode comprising a memory-based operating mode.

8. Microdisplay architecture according to claim 1, wherein the pixel matrix control comprises programmable and/or dynamically configurable cyclic transfer mimics configured to control the data flow between the memory and the light-emitting or light-modulating elements.

9. Microdisplay architecture according to claim 1, wherein the microdisplay architecture internally comprises a CPU/GPU that is configured to translate received or stored information into display pixel data and to display the same in several light-emitting or light-modulating elements.

10. Microdisplay architecture according to claim 1, wherein the microdisplay architecture internally comprises a graphics processor that is configured to control, in a refresh rate-based operating mode, the several light-emitting or light-modulating elements and can be switched off and/or put into a sleep mode in the memory-based operating mode.

11. Microdisplay architecture according to claim 1, wherein the pixel matrix control is configured to control several light-emitting or light-modulating elements grouped into a first group and to control several light-emitting or light-modulating elements grouped into a second group.

12. Microdisplay architecture according to claim 1, wherein the pixel matrix control is configured to vary the update rate;
and/or to control, in the memory-based operating mode, the several light-emitting elements with a lower update rate or no update rate or to control, in a refresh rate-based operating mode, the several light-emitting or light-modulating elements with a high update rate, in particular more than 30, more than 60, more than 90 or even more than 120 Hz.

13. Microdisplay architecture according to claim 1, wherein the pixel matrix control is configured to vary and/or to reduce a bit depth for controlling one or several respective ones of the several light-emitting or light-modulating elements.

14. Microdisplay architecture according to claim 1, wherein the several light-emitting or light-modulating elements of the optical plane and/or the image memory of the circuit plane comprise technology nodes <90 nm or <45 nm.

15. Microdisplay architecture according to claim 1, wherein the circuit plane comprises transistors comprising an additional leakage circuit.

16. Microdisplay architecture according to claim 15, wherein the leakage circuit comprises two transistors per light-emitting or light-modulating element.

17. Microdisplay architecture according to claim 1, wherein the image memory is integrated completely in the circuit plane allocated to a light-emitting or light-modulating element or wherein the image memory is implemented as image memory, partly arranged in the edge area or outside of the same, allocated to a light-emitting or light-modulating element; and/or
wherein the image memory comprises one or several bits per light-emitting or light-modulating element.

18. Microdisplay architecture according to claim 1, wherein the pixel matrix control is configured to switch off the image memory partly and/or in stages and/or completely or to bypass the same or to bypass the same for the refresh rate-based operating mode.

19. Microdisplay architecture according to claim 1, wherein the pixel matrix control comprises at least one switch and one driver per light-emitting or light-modulating element.

20. Microdisplay architecture according to claim 1, wherein the several light-emitting or light-modulating elements are implemented as common cathode circuit; and/or
wherein the pixel matrix control is configured to increase the brightness by decreasing the reference voltage V_{ref} or by increasing the pixel voltage Vₚᵢₓ₁ (or the brightness of the light-emitting/modulating elements is changed by changing the difference between the pixel voltage Vₚᵢₓ₁ and the reference voltage V_{ref}), or wherein the control is configured to control different light-emitting or light-modulating elements or pixel partial elements by different pixel voltages.

21. Microdisplay architecture according to claim 1, wherein the several light-emitting or light-modulating elements are configured as common anode circuit; and/or
wherein the pixel matrix control is configured to increase the brightness by increasing the reference voltage V_{ref} or by decreasing the pixel volage Vₚᵢₓ₂, or wherein the brightness of the light-emitting/modulating element is changed by changing a difference between the pixel voltage Vₚᵢₓ₂ and the reference voltage V_{ref}.

22. Microdisplay architecture according to claim 1, wherein the input frequency for image data at an input of the pixel matrix control and/or the memory is smaller than or equal to an output frequency for image data at an output of the pixel matrix control and/or the memory.

23. Microdisplay architecture according to claim 1, wherein the pixel matrix control is configured to control several light-emitting or light-modulating elements grouped into a first group and several light-emitting or light-modulating elements grouped into a second group; wherein a sequence and/or amplitude differs when controlling the first group and the second group.

24. Microdisplay architecture according to claim 1, wherein the pixel matrix control comprises a sequencer that is configured to provide different refresh rates from the memory for the light-emitting or light-modulating elements.

25. Microdisplay architecture according to claim 1, wherein the light-emitting or light-modulating elements are implemented as OLEDs, uLEDs or μLED or as LCOS.

26. Microdisplay architecture comprising:
an optical plane with several light-emitting or light-modulating elements;
a circuit plane on which the optical plane is arranged, wherein the circuit plane comprises a pixel matrix control for controlling the light-emitting or light-modulating elements, wherein the pixel matrix control comprises one or several transistors forming an additional leakage circuit.

27. Microdisplay architecture according to claim 26, wherein the leakage circuit comprises two further transistors per light-emitting or light-modulating element.

28. Method for controlling a microdisplay architecture according to claim 1, comprising:
operating the pixel matrix control in the memory-based operating mode by using the image memory; or
operating the pixel matrix control in a memory-based operating mode by/without using the image memory.

29. A non-transitory digital storage medium having a computer program stored thereon to perform the method for controlling an inventive microdisplay architecture according to claim 1, the method comprising:
operating the pixel matrix control in the memory-based operating mode by using the image memory; or
operating the pixel matrix control in a memory-based operating mode by/without using the image memory,
when the method runs on a pixel matrix control.
